(19) United States
(12) Patent Application Publication
(10) Pub. No.: US 2020/0154193 A1
(43) Pub. Date: May 14, 2020

(54) SIGNAL MODIFIER FOR SELF-COOLING HEADSETS

(71) Applicant: HEWLETT-PACKARD DEVELOPMENT COMPANY, L.P., Spring, TX (US)

(72) Inventors: David H. Hanes, Fort Collins, CO (US); Jon R. Dory, Spring, TX (US); James Glenn Dowdy, Fort Collins, CO (US)

(73) Assignee: HEWLETT-PACKARD DEVELOPMENT COMPANY, L.P., Spring, TX (US)

(21) Appl. No.: 16/603,406

(22) PCT Filed: Apr. 21, 2017
(86) PCT No.: PCT/US2017/028987

§ 371 Date: Oct. 7, 2019

(51) Int. Cl. H04R 1/10

(52) U.S. Cl. CPC H04R 1/1041; H04R 1/1008; H04R 2420/07; H04R 1/1075; H04R 1/1033

(57) ABSTRACT

In an example implementation, a self-cooling headset includes an ear cup to form an ear enclosure when placed over a user's ear. A first valve is to open and release air from the ear enclosure, and a second valve is to open and admit air into the ear enclosure. A speaker cone is to translate an audio signal into audible sound, and a signal modifier is to modify the audio signal with a subsonic frequency signal to cause the speaker cone to generate air movement that produces sufficient positive pressure to open the first valve and sufficient negative pressure to open the second valve.

### BACKGROUND

Audio headsets, headphones, and earphones generally comprise speakers that rest over a user's ears to help isolate sound from noise in the surrounding environment. While the term “headset” is sometimes used in a general way to refer to all three of these types of head-worn audio devices, it is most often considered to denote an ear-worn speaker or speakers combined with a microphone that allows users to interact with one another over telecom systems, intercom systems, computer systems, gaming systems, and so on. As used herein, the term “headset” is intended to refer to head-worn audio devices with and without a microphone. The term “headphones” can refer more specifically to a pair of ear-worn speakers with no microphone that allow a single user to listen to an audio source privately. Headsets and headphones often comprise ear cups that fully enclose each ear within an isolated audio environment, while earphones can fit against the outside of the ear or directly into the ear canal.

### BRIEF DESCRIPTION OF THE DRAWINGS

Examples will now be described with reference to the accompanying drawings, in which:

FIG. 1 shows an example of a self-cooling headset in which a signal modifier can provide a modified audio signal to drive a speaker cone to enable active cooling of the headset;

FIG. 2 shows an example of a self-cooling headset with additional details to illustrate an example construction and operation of the headset;

FIG. 3 shows an example of how an example umbrella check valve may be implemented within an entry and exit port of an ear cup;

FIG. 4 shows an example of a self-cooling headset that illustrates alternate operating modes for the headset;

FIG. 5 shows an example of a self-cooling headset illustrating an additional operating mode in which a coaxial speaker includes a first speaker cone to produce audible sound, and a second speaker cone to produce air movement for active cooling of the headset;

FIGS. 6, 7, and 8, are flow diagrams showing example methods of self-cooling a headset.

Throughout the drawings, identical reference numbers designate similar, but not necessarily identical, elements.

### DETAILED DESCRIPTION

Users who wear headsets, headphones, and other head-worn audio devices for extended periods of time can experience various types of discomfort. For example, users can experience ear pain from ill-fitting ear cups, pain in the temples from ear cups pressing against eyeglasses, general headaches from ear cups that press too tightly against the user's head, and so on. Another discomfort users often complain about is having hot ears. Gamers, for example, often use headsets for extended periods of time which can lead to increases in temperature within the ear cups and around the ears where the headset cushions press against their head. As a result, many gamers and other users often complain that their ears get hot, sweaty, itchy, and generally uncomfortable.

Headsets are generally designed so that the ear cushions press hard enough against a user's head to fully enclose each ear and to provide an audio environment favorable for producing quality sound from an incoming audio signal while blocking out unwanted noise from the ambient environment. Maintaining user comfort while providing such an audio environment can be challenging, especially during periods of extended use. In some examples, headsets can include features that help to alleviate discomforts such as the increases in temperature associated with extended use. In some examples, headsets have been designed to include a fan or fans to actively move air into and out of the enclosed areas surrounding the user's ears. In some examples, headsets have been designed to include open vents that enable a passive circulation of air into and out of the enclosed areas surrounding the user's ears. In some examples, headsets have been designed with ear cushions comprising materials capable of conducting heat away from the user's ears. Such designs can help to alleviate the increases in temperature associated with the extended use of headsets, but they can add considerable cost to the product while providing minimal relief.

Accordingly, in some examples describe herein, a self-cooling headset can modify an audio signal to include a low frequency signal that can drive a speaker transducer (alternately referred to herein as a speaker cone) to generate air movement through entry and exit ports in an ear cup, providing active cooling of the enclosed areas surrounding a user's ears. In general, the phrase “self-cooling headset” is intended to indicate a headset in which a cooling function is performed in an automated fashion as a user wears and operates the headset. The modified audio signal can include audio spectrum signals to drive the speaker cone to generate audible sound, as well as low frequency signals (e.g., subsonic frequency signals) to drive the speaker cone to generate air movement that is inaudible. The air movement generated from low frequency signals can create positive and negative pressures within an ear enclosure. The positive pressures can open a first valve to release air from the enclosure, and the negative pressures can open a second valve to admit air into the enclosure.

When appropriately driven by a low/subsonic frequency signal, the speaker cone refreshes air within the ear cup enclosure (i.e., the ear cup volume) by forcing air out of the enclosure through an exit port in a first or forward motion, and by drawing air into the enclosure through an entry port in a second or reverse motion. The first or forward motion of the speaker cone causes a positive pressure within the ear enclosure. A first check valve installed at the exit port opens to let air out of the enclosure when the positive pressure caused by the speaker cone overcomes the cracking pressure of the valve. The second or reverse motion of the speaker cone causes a negative pressure within the ear enclosure. A second check valve installed at the entry port opens to let ambient air into the enclosure when a negative pressure caused by the speaker cone overcomes the cracking pressure of the valve. The first and second check valves are installed in the ear cup in opposite orientations so that a positive pressure within the cup opens the first valve while sealing closed the second valve, and a negative pressure within the cup opens the second valve while sealing closed the first valve.

In a particular example, a self-cooling headset includes an ear cup to form an ear enclosure when placed over a user's ear, a first valve to open and release air from the ear enclosure, and a second valve to open and admit air into the ear enclosure. The headset also includes a speaker cone to translate an audio signal into audible sound, and a signal modifier to modify the audio signal with a subsonic frequency signal to cause the speaker cone to generate air movement within the ear enclosure. The air movement is to produce sufficient positive pressure to open the first valve and sufficient negative pressure to open the second valve.

In another example, a non-transitory machine-readable storage medium stores instructions that when executed by a processor of a self-cooling headset, cause the headset to determine that a speaker cone is in an idle cooling state. The headset can generate a low frequency signal with which to drive the speaker cone. Driving the speaker cone with the low frequency signal can put the speaker cone into an active cooling state, for example, by causing air movement that produces positive and negative pressures to open and close valves in an ear cup enclosure.

In another example, a method of self-cooling a headset includes installing a first valve in an exit port of an ear cup to release air from an ear cup volume, and a second valve in an entry port of the ear cup to admit air into the ear cup volume. The method also includes installing an audio signal receiver to receive an audio signal for driving a speaker cone to generate audible sound, and installing a signal modifier to modify the audio signal with a subsonic frequency signal. The subsonic frequency signal is to further drive the speaker cone to generate air movement to produce positive pressure sufficient to open the first valve and negative pressure sufficient to open the second valve.

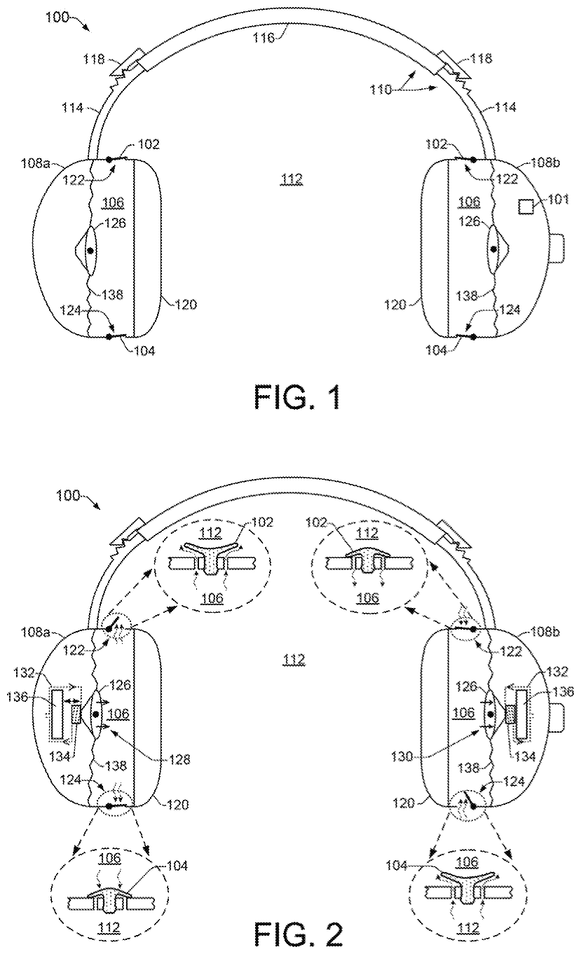

FIG. 1 shows an example of a self-cooling headset 100 in which a signal modifier 101 can provide a modified audio signal to drive a speaker cone to produce positive and negative air pressures that open and close check valves (102, 104) to enable active circulation of fresh air through the ear enclosure 106 of an ear cup 108. As discussed, described, illustrated, referred to, or otherwise used herein, a “check valve”, or “valve”, is intended to encompass any of a variety of valves, controllers, regulators, stopcocks, spigots, taps, or other devices that are capable of functioning as non-return-type valve devices that can enable air flow in a forward or first direction and prevent air flow in a backward or second direction. In some examples, such a valve device may include devices that employ alternate opening mechanisms such as sliding mechanisms that slide across an aperture to expose a port (e.g., ports 122, 124) or opening in the ear cup 108, different intersecting port shapes formed in the ear cup 108 that provide static openings, and so on. Thus, while the terms “check valve” or “valve” are used throughout this description, other similarly functional devices of all types are possible and are contemplated herein for use as or within any examples.

FIG. 2 shows an example of a self-cooling headset 100 illustrating additional details to facilitate further discussion of an example construction and operation of the headset 100. Referring generally to FIGS. 1 and 2, the self-cooling headset 100 can include an ear cup 108 for each ear (i.e., illustrated in the figures as two ear cups 108a, 108b). The ear cups 108 are illustrated in partial transparency in order to better illustrate details of the ear enclosure 106 areas and additional components within the ear cups 108. The ear enclosure 106 can be generally defined as the open space or volume between a user's ear and the speaker cone 126. In some examples the speaker cone 126 can be supported within the ear cup 108 by a “surround” 138 that flexibly attaches the speaker cone 126 to an outer frame or “basket” of the ear cup 108. Thus, the surround 138 in combination with the speaker cone 126 can define the space or volume of the ear enclosure 106.

Referring still to FIGS. 1 and 2, the two ear cups 108 that are to be worn over a user's ears can be coupled to one another by a head piece 110. The head piece 110 can be adjustable to accommodate users of varying ages and head sizes. The head piece 110 can be adjustable to firmly secure each ear cup 108 against a user's head in a manner that provides an ear enclosure 106 that is isolated from the ambient environment 112 outside of the ear cup 108. Greater isolation of the ear enclosure 106 area from the ambient environment 112 can provide an improved audio experience for the user. The head piece 110 can be adjustable, for example, with extendable and retractable end pieces 114 that telescope from a center piece 116 and latch into different positions with a latching mechanism 118. Wiring (not shown) can extend through the center piece 116 and end pieces 114 to carry electric signals and power between the two ear cups 108a,108b. Cushions 120 can be attached to each ear cup 108 to help provide comfort for the user and to improve isolation of the ear enclosure 106 from the ambient environment 112. Cushions 120 can be formed, for example, from soft rubber, foam, foam-rubber, and so on.

As noted above, first and second check valves, 102 and 104, enable active circulation of fresh air through the ear enclosures 106 of ear cups 108. In some examples, check valves can be installed in ports that are formed in the ear cup 108. Such ports can provide passage ways for air to travel from the outside ambient environment 112 into the ear enclosure 106, and back into the ambient environment 112 from the ear enclosure 106. The first check valve 102, for example, can be installed in an exit port 122 of the ear cup 108 to enable air from within the ear enclosure 106 to exit the enclosure 106 when the first check valve 102 opens. The second check valve 104 can be installed in an entry port 124 of the ear cup 108 to enable fresh air from the ambient environment 112 to enter the ear enclosure 106 when the second check valve 104 opens. In some examples, air within the ear enclosure 106 can be warm air that has been heated during use of the headset 100 due to its close proximity to a user's ear and its confinement within the limited area of the ear enclosure 106. Active movement of warm air out of the ear enclosure 106 through an exit port 122 coupled with active movement of fresh air into the ear enclosure 106 through an entry port 124 can help to maintain user comfort.

In some examples, as shown in FIG. 2, the exit port 122 is located toward the top of the ear cup 108 and the entry port 124 is located toward the bottom of the ear cup 108 to facilitate the removal of warm air from the ear enclosure 106 as it naturally rises within the enclosure 106. In other examples, the locations of the exit port 122 and entry port 124 on the ear cup 108 can be reversed such that the exit port 122 is located toward the bottom and the entry port 124 is located toward the top. In other examples, the exit port 122 and entry port 124 can be located at various different positions around the ear cup 108.

The first and second check valves, 102 and 104, can open and close to allow air to pass into and out of the ear enclosure 106 based on the valve orientations and based on a differential pressure between the volume of air within the ear enclosure 106 and the air in the ambient environment 112. As shown in FIG. 2, for example, the first check valve 102 comprises an outward oriented (i.e., outward opening) check valve that can open in a single outward direction to enable air to escape from the ear enclosure 106 through the exit port 122 and into the ambient environment 112. The first check valve 102 has an associated cracking pressure (i.e., opening pressure) that indicates a minimum opening pressure that will cause the check valve to open in the single outward direction. This is indicated in the left ear cup 108a of FIG. 2 by small wavy arrows pointing in a direction from inside the ear enclosure 106 to the ambient environment 112 outside of the ear cup 108a. Thus, when pressure within the ear enclosure 106 overcomes the cracking pressure of the first check valve 102, the first check valve 102 opens outward and allows air to escape from within the ear enclosure 106 and pass through the exit port 122 into the ambient environment 112. When the pressure within the ear enclosure 106 falls below the cracking pressure of the first check valve 102, the valve 102 closes. As noted above, a “check valve” as used throughout this description is intended to encompass other similarly functional devices of all types that are capable of functioning as non-return-type valve devices. Thus, a “cracking pressure” as used herein is intended to refer to, and generally apply to, any such devices as an “opening pressure” that is sufficient to begin to open any such device.

Similarly, but in an opposite way, the second check valve 104 comprises an inward oriented (i.e., inward opening) check valve that can open in a single inward direction to enable air to enter the ear enclosure 106 from the ambient environment 112 through the entry port 124. The second check valve 104 has an associated cracking pressure that indicates a minimum opening pressure that will cause the check valve to open in the single inward direction. This is shown in the right ear cup 108b of FIG. 2 by small wavy arrows pointing in a direction from the ambient environment 112 outside of the ear cup 108b and into the ear enclosure 106. Thus, when a partial vacuum or negative pressure within the ear enclosure 106 (i.e., negative pressure relative to the outside ambient environment 112) overcomes the cracking pressure of the second check valve 104, the second check valve 104 opens inward and allows fresh air from the ambient environment 112 to pass through the entry port 124 and into the ear enclosure 106. When the partial vacuum or negative pressure within the ear enclosure 106 falls below the cracking pressure of the second check valve 104, the valve 104 closes.

The first and second check valves, 102 and 104, can operate in an opposing manner with respect to one another. More specifically, while a positive pressure within the ear enclosure 106 acts to open the first check valve 102, as discussed above, it simultaneously acts to force the second check valve 104 closed. Similarly, while a partial vacuum or negative pressure within the ear enclosure 106 acts to open the second check valve 104, it simultaneously acts to force the first check valve 102 closed. In some examples, the cracking pressure of the first and second check valves can be the same pressure, while in other examples, the first and second check valves may have cracking pressures that are different from one another.

In different examples, the check valves 102 and 104 can be implemented using different types of check valves. Examples of different types of check valves that may be appropriate include diaphragm check valves, umbrella check valves, ball check valves, swing check valves, lift-check valves, in-line check valves, and combinations thereof. Thus, while check valves 102 and 104 are illustrated herein as being umbrella check valves, other types of check valves that can open to permit air to flow in a first direction and close to prevent air from flowing in an opposite direction are possible and are contemplated herein.

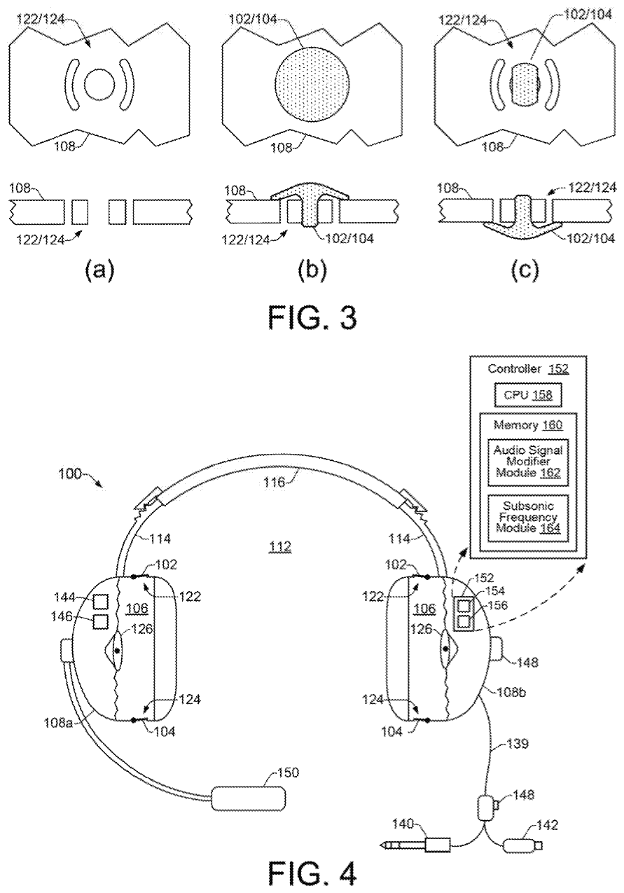

FIG. 3 shows a more detailed view of how an example umbrella check valve may be implemented within an entry and exit port 122/124 of an ear cup 108. FIG. 3a illustrates a top down view and a side view of an example entry or exit port 122/124 formed in the surface of an ear cup 108 that is suitable to accommodate an umbrella check valve. The example port includes a circular hole into which the valve of an umbrella check valve can be seated, and two passages through the ear cup 108 surface that enable air to pass between the ear enclosure 106 and the ambient environment 112. FIG. 3b illustrates a top down view and a side view of an example umbrella check valve 102/104 whose valve stem is seated in the port with the check valve closed over the two air passages of the port. FIG. 3c illustrates a bottom up view and a side view of an example umbrella check valve 102/104 whose valve stem is seated in the port with the check valve closed over the two air passages of the port.

As noted above, examples of a self-cooling headset 100 include a speaker cone 126 that can be driven with a modified audio signal that includes audio spectrum signals to generate audible sound, as well as subsonic frequency signals to generate inaudible air movement. An audio signal received by the headset 100 can include signals within the audible frequency range in which humans can hear, sometimes referred to as the audio spectrum. The audio spectrum is considered to cover audible frequencies between about 20 Hz to about 20,000 Hz. Thus, rendering audio signals (e.g., through speaker cone 126) can produce audible sound waves or vibrations within the ear enclosure 106 of an ear cup 108. An audio signal can be modified to include a subsonic frequency signal comprising signals that are below the audible frequency range. Thus, subsonic frequency signals can be signals below 20 Hz, and in some examples subsonic frequency signals are considered to cover frequencies between about 5 Hz to about 15 Hz. Rendering subsonic frequency signals through a speaker cone 126, for example, can produce air movement as subsonic or infrasonic waves or vibrations within the ear enclosure 106 of an ear cup 108 that are below the frequency of audible sound. Such subsonic or infrasonic waves, sometimes referred to as low-frequency “sound” or “infrasound”, can produce positive and negative air pressures within the ear enclosure 106 that can open and close check valves 102 and 104 to actively circulate fresh air through the enclosure 106.

Referring again generally to FIG. 2, example operations of the speaker cone 126 can be shown. During operation, the speaker cone 126 can translate in a forward direction 128 as shown in ear cup 108a, and in a reverse direction 130 as shown in ear cup 108b. Components of a speaker transducer that generate the forward and reverse motions of the speaker cone 126 include a voice coil 132 wrapped around a coil-forming cylinder 134, and a permanent/stationary magnet 136. During operation, incoming electrical signals (e.g., audio signals, subsonic signals) traveling through the coil 132 turn the coil 132 into an electromagnet that attracts and repels the permanent/stationary magnet 136. The attraction and repulsion of the magnet 136 by the coil 132 causes movement of the coil 132 and the speaker cone 126 in a forward and reverse direction according to the incoming electrical signals.

When driven with an audio signal in the audio spectrum frequency range, the speaker cone 126 can be made to translate back and forth in forward 128 and reverse 130 directions to create audible sound waves or vibrations within the ear enclosure 106 of an ear cup 108. When driven with a subsonic signal, the speaker cone 126 can be made to translate back and forth in forward 128 and reverse 130 directions through enough distance that effective, inaudible, air movement is generated to create positive and negative pressures within the ear enclosure 106 that open and close the first and second valves alternately to cause air circulation through the enclosure 106. More specifically, when the speaker cone 126 translates or moves in a forward direction 128 as shown in ear cup 108a, it can generate a positive pressure within the ear enclosure 106 that overcomes the cracking pressure of the first check valve 102, which causes the valve 102 to open and release air from the ear enclosure 106 into the ambient environment 112. Similarly, but oppositely, when the speaker cone 126 translates or moves in a reverse direction 130 as shown in ear cup 108b, it can create a partial vacuum or negative pressure within the ear enclosure 106 (i.e., a negative pressure differential between the ear enclosure 106 and ambient environment 112) that can overcome the cracking pressure of the second check valve 104, which causes the valve 104 to open and admit fresh air from the ambient environment 112 into the ear enclosure 106.

FIG. 4 shows an example of a self-cooling headset 100 illustrating alternate example operating modes and additional details of an example construction and operation of the headset 100. As noted above, the speaker cone 126 can be driven by an audio signal to produce audible sound. Accordingly, a headset 100 can include an audio signal receiver such as an audio cable 139 to receive power and audio signals from an audio source, such as a stereo system, a gaming system, or a computer system (not shown). The audio cable 139 can include an audio jack 140 and/or USB plug 142 to plug into the audio source. Thus, an audio cable 139 with an audio jack 140 and/or USB plug 142 can act as a wired audio signal receiver and power receiver. In some examples, a self-cooling headset 100 can comprise a wireless headset powered by batteries or a battery pack 144. Thus, a headset can include an audio frequency signal receiver implemented as an onboard wireless receiver 146. Some examples of a wireless receiver 146 can include a Bluetooth receiver, a zigbee receiver, a z-wave receiver, a near-field-communication (nfc) receiver, a wi-fi receiver, and an RF receiver. In some examples, a control dial 148 can be positioned on the audio cable 139 or on an ear cup 108. A control dial 148 can be used, for example, to adjust audio volume and select between different audio signals coming through the audio cable 139 or through a wireless receiver 146. In some examples, a self-cooling headset 100 can include a microphone 150 coupled to an ear cup 108. Computer gaming headsets often include a microphone to enable interaction between players.

As shown in FIG. 4, in some examples a self-cooling headset 100 includes a controller 152 that can perform various functions such as providing an audio signal modifier 154 and an on-board subsonic frequency generator 156. An audio signal modifier 154 can monitor various characteristics of a received audio signal to determine whether the speaker cone 126 is in an active cooling state (i.e., actively cooling the headset) or an idle or inactive cooling state. The audio signal modifier 154 can determine characteristics of a received audio signal including, for example, a frequency range of the audio signal, the amplitude of the audio signal, gaps in the audio signal where there may be very low or no amplitude in the signal, and so on. From these audio signal characteristics, the audio signal modifier 154 can determine moment by moment whether or not a low frequency (e.g., subsonic frequency) signal component is present within the received audio signal to drive the speaker cone 126 in a manner that can create air movement for active cooling of the headset 100. Thus, the audio signal modifier 154 knows when the speaker cone 126 is in an active cooling state or an inactive cooling state.

In some examples, when the speaker cone 126 is in an inactive/idle cooling state, the audio signal modifier 154 can modify the received audio signal to include a low frequency (e.g., subsonic frequency) signal with the audio signal. The subsonic frequency generator 156 can generate a subsonic frequency signal to be used alone or in combination with a received audio signal to drive the speaker cone 126. Thus, modification of an audio signal with a subsonic frequency enables driving the speaker cone 126 to produce air movement that creates positive and negative pressures within the ear enclosures 106 that can open and close valves 102 and 104 to put the speaker cone 126 in an active cooling state for active cooling of the headset 100.

Example circumstances in which the audio signal modifier 154 may perform such signal modification include those in which a received audio signal will not, on its own, drive the speaker cone 126 to provide such active cooling of the headset 100. For example, in circumstances where the audio signal modifier 154 determines that a received audio signal has a limited frequency range that does not extend low enough (e.g., below about 20 Hz, into the subsonic range) to drive the speaker cone 126 to provide active cooling, the signal modifier 154 can modify the audio signal to include a subsonic frequency signal. Other circumstances can include, for example, when the audio signal modifier 154 determines that the amplitude of a received audio signal is too low to drive the speaker cone 126 to provide active cooling, or when the audio signal modifier 154 determines that the received audio signal includes signal gaps where the audio signal cuts out, or when the audio signal modifier 154 determines that the received audio signal includes amplitude gaps where there may be very low or no amplitude in the signal, and so on. In some examples, the audio signal modifier 154 may also function to apply a subsonic frequency to the speaker cone 126 when there is no audio signal being received by the headset 100. In such cases, the audio signal modifier 154 operates to provide active cooling of the headset 100 even while no audio is being generated by the speaker cone 126. In some examples, the audio signal modifier 154 may function to apply a subsonic frequency to the speaker cone 126 after the amplitude of an audio signal being received by the headset 100 exceeds a preset amplitude. In such cases, the audio signal modifier 154 operates to provide active cooling of the headset 100 while the volume of audio being generated by the speaker cone 126 is sufficient to overcome incidental noise that may be caused by operation of the valves 102 and 104.

Referring still to FIG. 4, in some examples a controller 152 can include a processor (CPU) 158 and a memory 160. The controller 152 may additionally or alternately include other electronics (not shown), such as discrete electronic components and an ASIC (application specific integrated circuit). Memory 160 can include both volatile (i.e., RAM) and nonvolatile memory components (e.g., ROM, flash memory, etc.). The components of memory 160 comprise non-transitory, machine-readable (e.g., computer/processor-readable) media that can provide for the storage of machine-readable coded program instructions, data structures, program instruction modules, and other data and/or instructions executable by a processor 158. Thus, the audio signal modifier 154 and subsonic frequency generator 156 each generally comprise a processor 158 programmed with instructions that when executed, can cause the headset 100 to generate a subsonic frequency signal and determine when to modify an audio signal with the subsonic signal to achieve active cooling of the headset 100. For example, the audio signal modifier 154 can comprise the processor 158 programmed to execute instructions from an audio signal modifier module 162 stored in memory 160, while the subsonic frequency generator 156 can comprise the processor 158 programmed to execute instructions from a subsonic frequency module 164 stored in memory 160. Thus, modules 162 and 164 include programming instructions executable by processor 158 to cause the self-cooling headset 100 to perform various functions related to subsonic frequency generation and audio signal modification, such as the operations of methods 600, 700, and 800, described below with respect to FIGS. 6, 7, and 8.

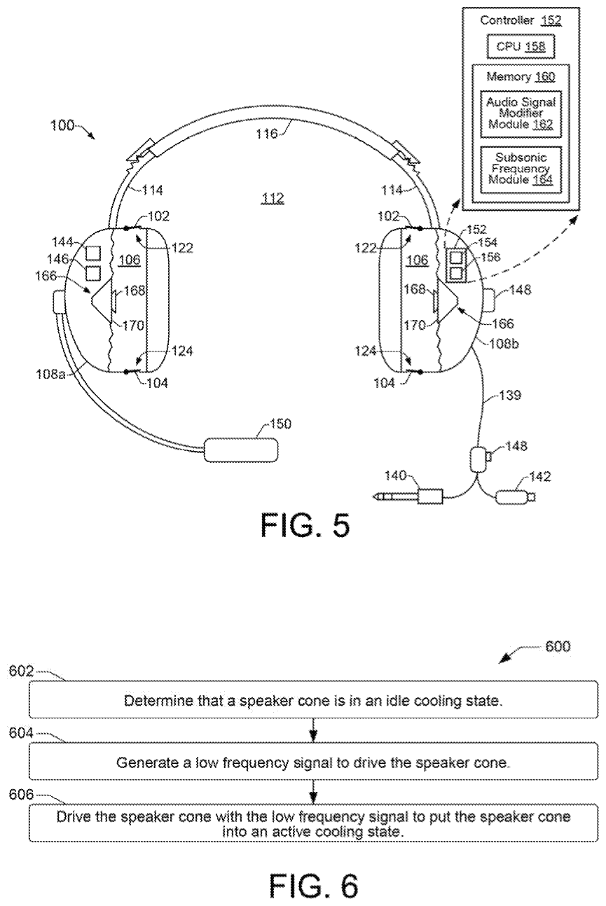

FIG. 5 shows an example of a self-cooling headset 100 illustrating an additional operating mode in which a coaxial speaker 166 includes a first speaker cone 168 to produce audible sound, and a second speaker cone 170 to produce positive and negative air pressures that open and close check valves (102, 104) to enable active circulation of fresh air through the ear enclosure 106 of an ear cup 108. In general, some examples of coaxial speakers can comprise two-way speakers in which a “tweeter” or high-range cone is mounted coaxially in front of a “woofer” or low-range cone. Thus, the example coaxial speaker 166 shown in FIG. 5 includes two speaker cones; i.e., a first speaker cone 168 analogous to a tweeter for producing audible sound, and a second speaker cone 170 analogous to a woofer for creating positive and negative air pressures to enable active cooling of the headset 100.

The general operation of the headset 100 shown in FIG. 5 is similar to the operation discussed above with regard to FIGS. 1-4, except that the first speaker cone 168 can be used to translate audio signals in the audible spectrum into sound, while the second speaker cone 170 can be used to translate subsonic signals into air movement to enable active cooling of the headset 100. In some examples, therefore, when a self-cooling headset 100 includes a coaxial speaker 166, the audio signal modifier 154 can determine a frequency range of a received audio signal and direct audio spectrum frequencies of the audio signal to the first speaker cone 168 while directing subsonic frequencies of the audio signal to the second speaker cone 170. Where a received audio signal is determined to not include subsonic frequencies, the audio signal modifier 154 can direct a subsonic frequency signal from the subsonic frequency generator 156 to the second speaker cone 170.

FIGS. 6, 7, and 8, are flow diagrams showing example methods 600, 700, and 800, of self-cooling a headset. Method 700 comprises extensions of method 600 that incorporate additional details. The methods 600, 700, and 800 are associated with examples discussed above with regard to FIGS. 1-5, and details of the operations shown in methods 600, 700, and 800 can be found in the related discussion of such examples. The operations of methods 600 and 700 may be embodied as programming instructions stored on a non-transitory, machine-readable (e.g., computer/processor-readable) medium, such as memory 160 shown in FIG. 4. In some examples, implementing the operations of methods 600 and 700 can be achieved by a processor, such as a processor 158 of FIG. 4, reading and executing the programming instructions stored in a memory 160. In some examples, implementing the operations of methods 600 and 700 can be achieved using an ASIC and/or other hardware components alone or in combination with programming instructions executable by a processor 158.

In some examples, the methods 600, 700, and 800 may include more than one implementation, and different implementations of methods 600, 700, and 800 may not employ every operation presented in the flow diagrams of FIGS. 6-8. Therefore, while the operations of methods 600, 700, and 800 are presented in a particular order within their respective flow diagrams, the order of their presentation is not intended to be a limitation as to the order in which the operations may actually be implemented, or as to whether all of the operations may be implemented. For example, one implementation of method 700 might be achieved through the performance of a number of initial operations, without performing one or more subsequent operations, while another implementation of method 700 might be achieved through the performance of all of the operations.

Referring now to the flow diagram of FIG. 6, an example method 600 of self-cooling a headset begins at block 602 with determining that a speaker cone is in an idle cooling state. Upon determining that a speaker cone is in an idle cooling state, a low frequency signal can be generated to drive the speaker cone, as shown at block 604. As shown at block 606, the speaker cone can be driven with the low frequency signal to put the speaker cone into an active cooling state.

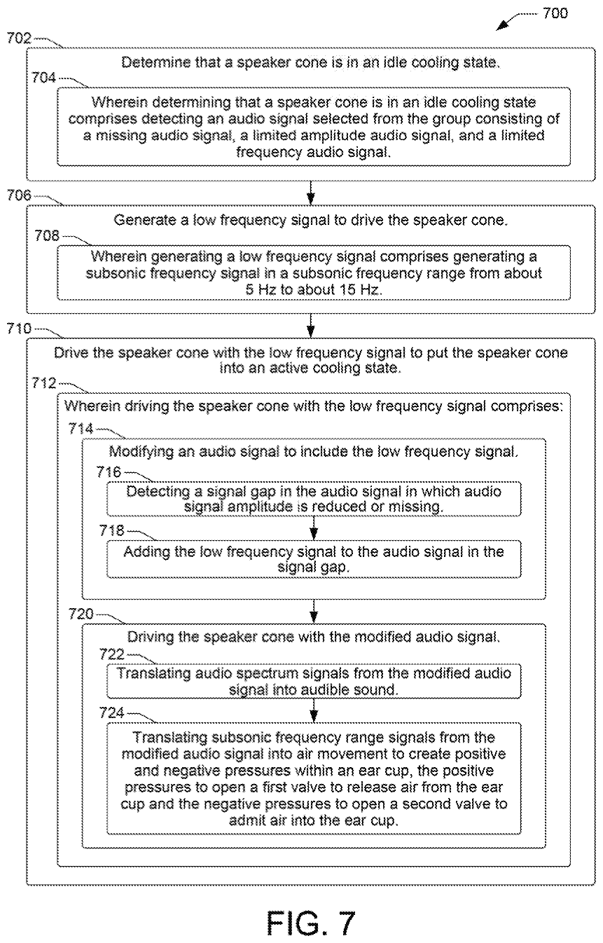

Referring now to the flow diagram of FIG. 7, another example method 700 of self-cooling a headset is shown. As noted above, method 700 is an extension of example method 600 that incorporate additional details. Thus, as shown at block 702, the example method 700 can include determining that a speaker cone is in an idle cooling state. In some examples, as shown at block 704, determining that a speaker cone is in an idle cooling state can include detecting an audio signal selected from the group consisting of a missing audio signal, a limited amplitude audio signal, and a limited frequency audio signal. The method 700 can continue as shown at block 706, with generating a low frequency signal to drive the speaker cone. In some examples, as shown at block 708, generating a low frequency signal can include generating a subsonic frequency signal in a subsonic frequency range from about 5 Hz to about 15 Hz.

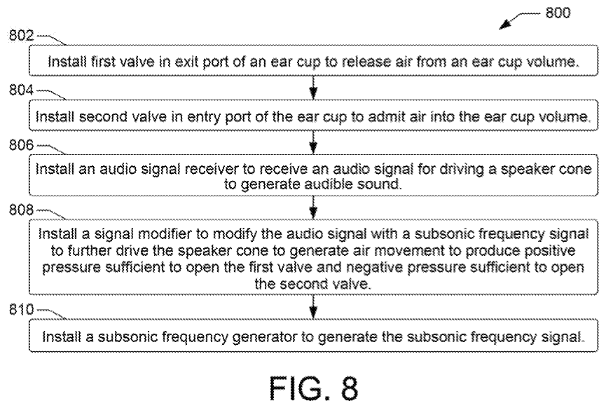

Continuing at block 710, method 700 can include driving the speaker cone with the low frequency signal to put the speaker cone into an active cooling state. As shown at blocks 712 and 714, driving the speaker cone with the low frequency signal can include modifying an audio signal to include the low frequency signal. As shown at blocks 716 and 718, modifying an audio signal to include the low frequency signal can include detecting a signal gap in the audio signal in which audio signal amplitude is reduced or missing, and adding the low frequency signal to the audio signal in the signal gap. As shown at block 720, driving the speaker cone with the low frequency signal can also include driving the speaker cone with the modified audio signal. As shown at blocks 722 and 724, driving the speaker cone with the modified audio signal can include translating audio spectrum signals from the modified audio signal into audible sound, and translating subsonic frequency range signals from the modified audio signal into air movement to create positive and negative pressures within an ear cup, where the positive pressures are to open a first valve to release air from the ear cup and the negative pressures are to open a second valve to admit air into the ear cup. —Referring now to the flow diagram of FIG. 8, another example method 800 of self-cooling a headset can begin with installing a first valve in an exit port of an ear cup to release air from an ear cup volume, and installing a second valve in an entry port of the ear cup to admit air into the ear cup volume, as shown respectively at blocks 802 and 804. The method 800 can also include installing an audio signal receiver to receive an audio signal for driving a speaker cone to generate audible sound, as shown at block 806. As shown at block 808, the method 800 can include installing a signal modifier to modify the audio signal with a subsonic frequency signal to further drive the speaker cone to generate air movement to produce positive pressure sufficient to open the first valve and negative pressure sufficient to open the second valve. As shown at block 810, the method 800 can also include installing a subsonic frequency generator to generate the subsonic frequency signal.

What is claimed is:

1. A self-cooling headset comprising:
an ear cup to form an ear enclosure when placed over a user's ear;
a first valve to open and release air from the ear enclosure;
a second valve to open and admit air into the ear enclosure;
a speaker cone to translate an audio signal into audible sound; and,
a signal modifier to modify the audio signal with a subsonic frequency signal to cause the speaker cone to generate air movement that produces sufficient positive pressure to open the first valve and sufficient negative pressure to open the second valve.

2. A self-cooling headset as in claim 1, wherein the signal modifier comprises a subsonic frequency generator to generate the subsonic frequency signal.

3. A self-cooling headset as in claim 2, wherein the subsonic frequency generator comprises:
a memory to store a subsonic frequency pattern and subsonic frequency generation instructions;
a processor programmed with the subsonic frequency generation instructions to control the speaker cone to translate the subsonic frequency signal into air movement that produces the positive and negative air pressures.

4. A self-cooling headset as in claim 1, further comprising an audio signal receiver selected from the group consisting of an audio cable and a wireless receiver.

5. A self-cooling headset as in claim 2, wherein the subsonic frequency generator comprises an independent generator to drive the second speaker cone independent of the audio frequency signal.

6. A self-cooling headset as in claim 1, wherein:
the first and second valves comprise, respectively, first and second cracking pressures;
the first cracking pressure can be overcome to open the first valve by a positive air pressure produced from the speaker cone; and,
the second cracking pressure can be overcome to open the second valve by a negative air pressure produced from the second speaker cone.

7. A self-cooling headset as in claim 1, further comprising an audio signal receiver selected from the group consisting of an audio cable and a wireless receiver.

8. A non-transitory machine-readable storage medium storing instructions that when executed by a processor of a self-cooling headset, cause the headset to:
determine that a speaker cone is in an idle cooling state;
generate a low frequency signal to drive the speaker cone; and,
drive the speaker cone with the low frequency signal to put the speaker cone into an active cooling state.

9. A medium as in claim 8, wherein driving the speaker cone with the low frequency signal comprises:
modifying an audio signal to include the low frequency signal; and,
driving the speaker cone with the modified audio signal.

10. A medium as in claim 9, wherein modifying an audio signal comprises:
detecting a signal gap in the audio signal in which audio signal amplitude is reduced or missing; and,
adding the low frequency signal to the audio signal in the signal gap.

11. A medium as in claim 8, wherein generating a low frequency signal comprises generating a subsonic frequency signal in a subsonic frequency range from about 5 Hz to about 15 Hz.

12. A medium as in claim 9, wherein driving the speaker cone with the modified audio signal comprises:
translating audio spectrum signals from the modified audio signal into audible sound; and,
translating subsonic frequency range signals from the modified audio signal into air movement to create positive and negative pressures within an ear cup, the positive pressures to open a first valve to release air from the ear cup and the negative pressures to open a second valve to admit air into the ear cup.

13. A medium as in claim 8, wherein determining that a speaker cone is in an idle cooling state comprises detecting an audio signal selected from the group consisting of a missing audio signal, a limited amplitude audio signal, and a limited frequency audio signal.

14. A medium as in claim 8, wherein the speaker cone comprises a coaxial speaker cone with a first cone and a second cone, and wherein driving the speaker cone with the low frequency signal comprises:
modifying an audio signal to include the low frequency signal;
driving the first cone with audible spectrum frequencies from the modified audio signal; and,
driving the second cone with the low frequency signal from the modified audio signal.

15. A method of self-cooling a headset comprising:
installing a first valve in an exit port of an ear cup to release air from an ear cup volume;
installing a second valve in an entry port of the ear cup to admit air into the ear cup volume;
installing an audio signal receiver to receive an audio signal for driving a speaker cone to generate audible sound;
installing a signal modifier to modify the audio signal with a subsonic frequency signal to further drive the speaker cone to generate air movement to produce positive pressure sufficient to open the first valve and negative pressure sufficient to open the second valve; and,
installing a subsonic frequency generator to generate the subsonic frequency signal.
